(19) United States
(12) Patent Application Publication
(10) Pub. No.: US 2007/0202241 A1
(43) Pub. Date: Aug. 30, 2007

(54) Process For Manufacturing Chocolate Mass, Machine And Compact Installation For The Chocolate Mass Processing

(75) Inventor: Flavio da Cruz Abaurre, Vitoria (BR)

Correspondence Address: BIRCH STEWART KOLASCH & BIRCH, PO BOX 747, FALLS CHURCH, VA, 22040-0747, US

(73) Assignee: MELLER EQUIPAMENTOS E TECHNOLOGIA, INDUSTRIA E COMERCIO LTDA., Vila Vehiha, ES (BR)

(21) Appl. No.: 10/588,964

(22) PCT Filed: Jul. 8, 2004
(86) PCT No.: PCT/BR04/00111

§ 371 Date: Apr. 23, 2007

(30) Foreign Application Priority Data
Feb. 11, 2004 (BR) PI04 00056-0

(51) Int. Cl. A23G 3/00

(52) U.S. Cl. 426/660

(57) ABSTRACT

The invention is related to a process for chocolate mass manufacturing, that comprises the following steps: a) dry pre-grinding of raw material; b) product conching in “U” type conch 9 for intensive chocolate processing, c) liquefaction and cooling of chocolate mass; d) final grinding of chocolate mass. The invention is still related to the chocolate mass processing machine, which is comprised by a structure made up of a “U” type shape conch 9, an agitator axis 12, in which a fixed arm 10 and agitator arms 11 are articulated, to increase the exposition cycle of dry chocolate mass to pre-heated air coming from the forced ventilation performed through the high pressure fan 14, activated by an electric motor with a heating electric resistance 13 to a compact installation for the processing of the chocolate mass with the above mentioned machine.

The process of manufacturing chocolate is a subject of public domain, widely disclosed in books and specialized technical publications. Nevertheless, with industry evolution in the manufacturing of new equipment throughout the last century, this process is being gradually improved to the current present levels.

Chocolate is a product that has its consumption habit widely spread in all continents of the planet. The manufacturing process methodology started to be standardized in Europe early in the twentieth century, where its basic processing principles were institutionalized. Such basic principles consisted of: mixing, grinding and homogenizing under intense and constant agitation.

In order to execute said process, a machine denominated “melageur” was used in the beginning of twentieth century, which consisted of a combination of mixer and granite rolling mill (today this equipment is outdated with very low processing efficiency).

The ingredients for the chocolate manufacturing, which basically consist of: cocoa mass, cocoa butter, sugar and eventually milk (in case of milk chocolate), were added to said machine in order to be mixed together and concurrently grounded through mechanical crushing of the heavy granite rolling mill (a standard final thickness in the range of 40 to 50 micra was obtained, which is unacceptable by the current standards that oscillates in the range of 16 to 25 micra), thus producing the basic mass for the manufacturing of chocolate topping.

Subsequently, the duly grounded mass (50 to 40 micra) was added to an equipment de-nominated “arm conch for the processing of chocolate” (such equipment is currently outdated since it does not perform the correct chocolate processing execution and does not meet the ongoing required standards in the market).

The conch had a self-heating container and eccentric arms which were mechanically articulated by a camshaft which provided an alternative movement to a heavy steel roll fixed to its end. The chocolate mass, already in its liquid form (with the remaining of the cocoa butter of the added formulation), was kept therein under constant agitation for as long as twenty four to seventy two hours in order to reach the development of a full flavor of the chocolate topping (this processing period is not acceptable by the current chocolate topping processing industries).

The evolution of the machine manufacturing industry throughout the twentieth century has enabled the modernization of the original processing equipment for the manufacturing of chocolate and brought about the first significant alteration that sought higher efficiency in the processing work, besides the improvement of its qualitative characteristics.

Thus, the process carried out in the past by the “melageur” (mix/grinder with granite rolls) was substituted by the efficient work performed in the mass by a rotating arms sigma type mixer, which was followed by the addition of a new equipment denominated “cylinder mill”, known as “chocolate refining”.

Such alteration has enabled higher efficiency in the productive processing of chocolate topping as well as the improved homogenization of the mass mix which will make future grindings easier by the “chocolate refining machine” (rolling mill). This will make a substantial improvement in the thickness patterns of the chocolate topping (16 to 20 micra in the current thickness patterns), reaching higher industrial performance and productivity in the organoleptic qualities of the final product.

Throughout the twentieth century, several conch models have come up seeking to improve the work performed by the outdated alternative arms “chocolate processing conch” (cycle of 72 hours).

The equipment placed in the market by the industry of equipments for the manufacture of chocolate topping are characterized by producing higher mechanical work through its mechanical arms. In this way, high power motors have been installed to move the mechanical arms acting with their slow mixers that constantly revolve the chocolate mass topping. The latter can cause high friction to the chocolate mass topping, which processing characteristic is fundamental for developing the final correct flavor of the chocolate topping.

The upcoming of more powerful machines into the market has enabled a basic chocolate processing change during the “conching” process (as compared to the previous used alternative arms conch). The great innovation was the division of the chocolate mass topping conching, which was performed only during the liquid phase (with all the cocoa butter of the added formula), into two new distinct phases. The first one known as “dry conching” (where only part of the butter in the formulation of chocolate topping is added to the mix, thus enabling a dry mass with the adding of the flour) followed by the “humid conching” (where the remaining of the cocoa butter in the formula will be added to liquefy the topping mass with a consistency of a very viscous liquid).

With the upcoming of the possibility to use the above described equipments (mixer, chocolate refining and chocolate conch) the current process used by the chocolate manufacturing industry is characterized by the following:

The ground sugar in hammer mills (180 micra thickness) is added together with the other ingredients of the formula, namely, cocoa mass, part of the cocoa butter in the final formula and eventually powder milk (in the case of chocolate milk), into the recipient of the rotating arms horizontal mixer. The chocolate topping mass ingredients are then mixed, heated at 40° C. and homogenized, until they acquire a firm and sticky mass consistency.

In the subsequent steps, the chocolate topping mass grinding (refining) is carried out (only with part of the total butter in the formula, around 24% of the total fat in the formula) using the “five cylinders refining” machine (thickness obtained of 16 to 25 micra). The mixture leaves this machine as a thin powder which already has its final thickness characteristics (temperature of 45° C.).

Thereafter, the powder (16 to 25 micra) coming from the chocolate mass refining is added to the equipment recipient denominated “chocolate conch”, in which it will receive the treatment for developing the characteristic flavor of the chocolate topping. This is the last processing stage and it is divided into two phases: “dry conching” and “humid conching.”

In the first phase, where the mass has the consistency of flour (24% of total fat), the mass undergoes a strong mechanical work through the stirring arms of the “chocolate processing conch”, usually two to six arms, with the basic purpose to develop the chocolate topping scent and flavor, besides improving its viscous characteristics for the partial elimination of the humidity retained in the chocolate topping mass (amounts computed from 1 to 0.5% humidity). Such viscous characteristic is fundamental to enable a good mass workability for the topping of bonbons and chocolate candies (the ideal viscosity is 300,000 to 340,000 Pa·s).

The removal of the humidity is carried out through heat generation caused by the strong friction of the mechanical arms of the conch which provides a strong heating to the mass (maximum temperature of 60° C. which should be respected due to the crystallization of the ground sugar thus generating clots in the product).

Such mechanical arms, which are rotating at a low speed, execute a movement that seek to insert a certain quantity of fresh air in the interior of the dry chocolate mass with the purpose to oxidize the tannin, anthocyanin and the remaining acetic acid wastes from the cocoa almonds fermentation, which are responsible for the product astringency and acid characteristics. At this stage, the product is subject to constant agitation, at low speed, under controlled temperature, which should not exceed much more than 60° C., otherwise it will occur the risk of re-crystallization of the refined sugar, thus making product futile when hard clots are formed for losing its essential thickness feature. At this stage, the chocolate mass topping is processed in periods of 12 to 16 hours, after which the remaining of the formulation butter will be added therein (thus completing 30% to 36% of the fat content which is normally found in the chocolate toppings) and thoroughly liquefying the chocolate mass topping and starting what is characterized as the “humid conching” in periods of 6 to 12 hours, and completing a total average processing of 24 hours per processing batch.

The chocolate mass will remain in this processing phase under constant agitation, with the mechanical arms moving at high speed to undo the dry mass in the remaining of the added butter under the controlled temperature (60° C.).

The present invention is based on the use of auxiliary equipments with high operational performance rate associated to an unique processing methodology, thus obtaining low energy consumption, operational cycle and processing installation cost vis-à-vis the produced chocolate volume, upon comparing same to more recent and modern chocolate processing techniques. This is only possible due to the use of a “U” type conch for processing chocolate, which is also the object of the current invention. The chemical and organoleptic characteristics are kept if the most modern conventional chocolate processing is used.

The purpose of the present invention is to improve the current chocolate topping manufacturing with low fixed assets and installation equipment when comparing to the conventional equipment costs used for such purpose, by using a new equipment (“U” type chocolate conch), especially developed as a support for this new processing form during the important step of the chocolate manufacturing process known as “(humid and dry) conching chocolate topping mass”.

As a result of the use of this technology, a new processing compact unit may be used, occupying a small physical area in the plant complex (upon comparing to an area at least three times bigger of a conventional plant) and with a low operational cost with regards to the used power versus the produced chocolate topping ton and labor directly involved in the productive processing.

This will also enable the achievement of an expressive improvement in the overall time of “conching processing” of the chocolate mass topping flavor and final viscosity, if they are used in the bonbons filling and general candies, where the product fluidity is necessary.

The manufacturing process herein used for the chocolate topping manufacturing, which is the purpose of this invention, intends to establish a system characterized by:
Low fixed assets equipments cost and auxiliary components, when compared to a production volume equal to the current manufacturing processes equivalent to those performed by equipments and conventional processes. Therefore small and medium companies may also make capital expenditures for the manufacturing of their own chocolate topping. This possibility was remote due to the high conventional installation cost vis-à-vis the companies' production scale;
Low cost and operational simplicity, which make feasible the direct operational labor cost, even for small production scales, thus making competitive in costs the chocolate produced in the processing unit of present invention, even for small production scale in both small and medium companies;
The installed electric power significantly lower (50% lower), when compared to conventional manufacturing chocolate plants that produce chocolate with the same quality. The result will be a low cost of installation and electric power consumption, vis-à-vis the chocolate volume produced under this invention for similar volumes of chocolate produced through conventional means;
Smaller physical area for the production equipments installation (30% of installed area for a conventional plant of the same capacity) if it is compared to chocolate topping plants that have the same chocolate topping quality and the same volume produced;
Operational simplicity characterized by the linear productive processing system, which enables a high automation level for the processing stages with low capital spending and medium level labor qualification without jeopardizing final product quality.

The present invention comprises a new optimized and compact design of the current chocolate mass manufacturing technology with alternative resources for an intensive processing; besides the use of equipment and auxiliary equipment which are specifically developed for this purpose and that are integral parts of this invention. It is also provided a low reduced operational time at low operational cost to the system user, when compared to the used conventional processes for the same purpose.

The raw material to be used, namely, cocoa mass and butter, sugar, powder milk, is received in its dry original form and as provided by the respective manufacturer (such ingredients are an integral part of the chocolate mass formulation). It is added into the dry pre-grinding system that follows by mechanized transportation to the “U” type conch for intensive processing chocolate, which was especially developed for this new processing design. The raw material will then undergo (in its dry form) an intensive conch treatment during a pre-determined time (4 to 8 hours).

The already liquefied chocolate mass is then transported through a positive displacement pump to a rolling mill where it will undergo final rolling treatment to reach the thickness as specified by the market (20-40 micra), and it will follow through a tube to the stock tank where the chocolate mass (in its liquid form) will await until it is solid after the final processing.

The invention's purpose is to improve and facilitate the chocolate manufacturing process, without however disregarding important processing stages already known, such as “chocolate mass conching” (dry and humid).

The invention is based on the fact that the complex interactions that occur among the sugars, proteins, and amino acids, which in their turn comprise the preceding chocolate flavor and scent characteristics during the dry and humid conching chocolate mass processing, follow well defined and known procedural parameters, but that nonetheless are not optimized in the industrial practice.

In order to achieve the proposed purpose it is necessary to use an intensive “U” type conch treatment, where through a very special configuration, it will enable that the above mentioned chemical reactions will occur in a period of time shorter than that provided by the current existing conventional processing systems.

As a benefit arising from this invention, it may also be mentioned the possibility to configure a compact processing unit that will require a small physical area in the plant complex (where in a conventional plant it would be necessary an area at least three times larger). In addition, it would have a low operational cost with regards to the power used vis-à-vis the produced chocolate topping per ton. This should also optimize the direct “labor” involved in the productive processing.

As additional benefit, it should be achieved an expressive improvement of the overall “conching” (processing) time of chocolate topping mass, of its flavor and of its final viscosity. This will enable better product workability if it is to be used in the topping of bonbons fillings and candies, in general, where higher product fluidity is always necessary.

The invention described hereunder with regard to the attached drawings shows that:

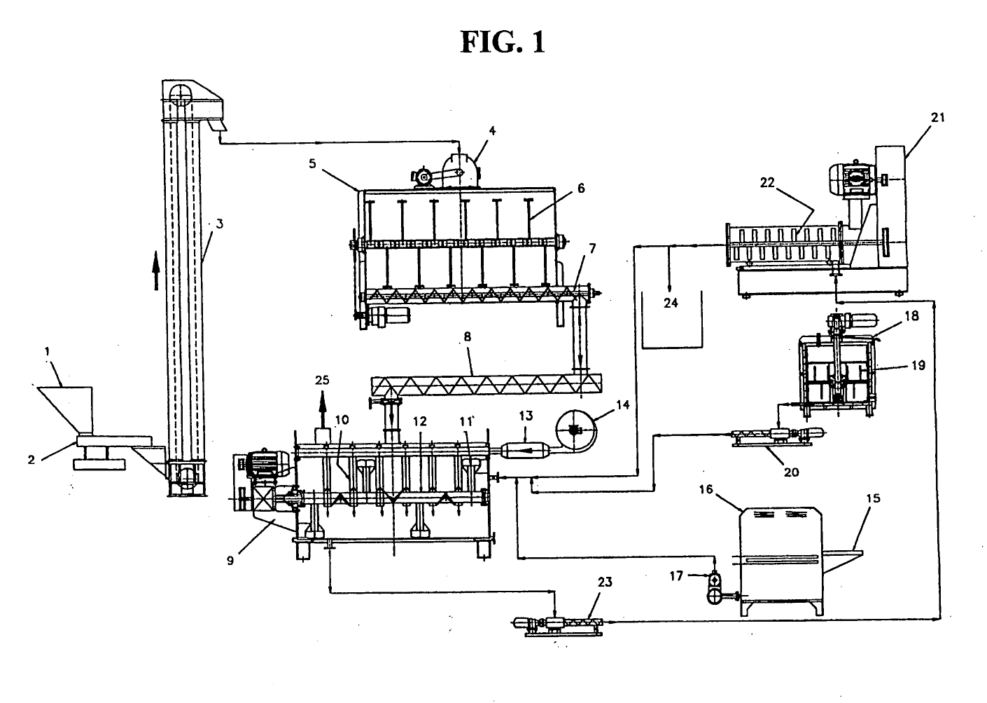

FIG. 1 shows a chocolate manufacturing system flow chart in accordance with the present invention.

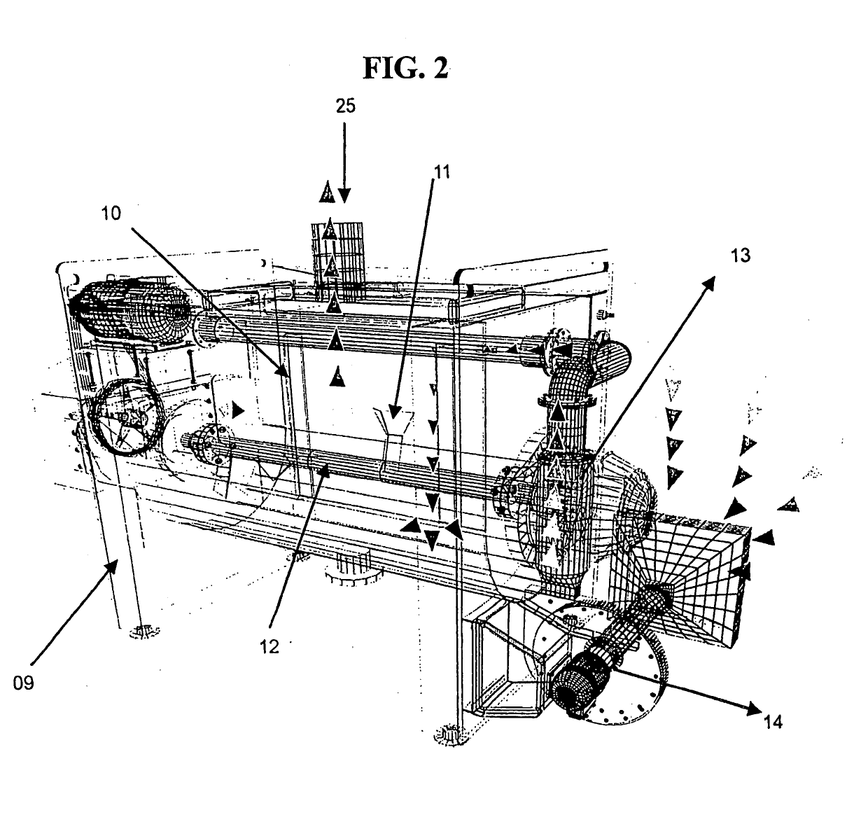

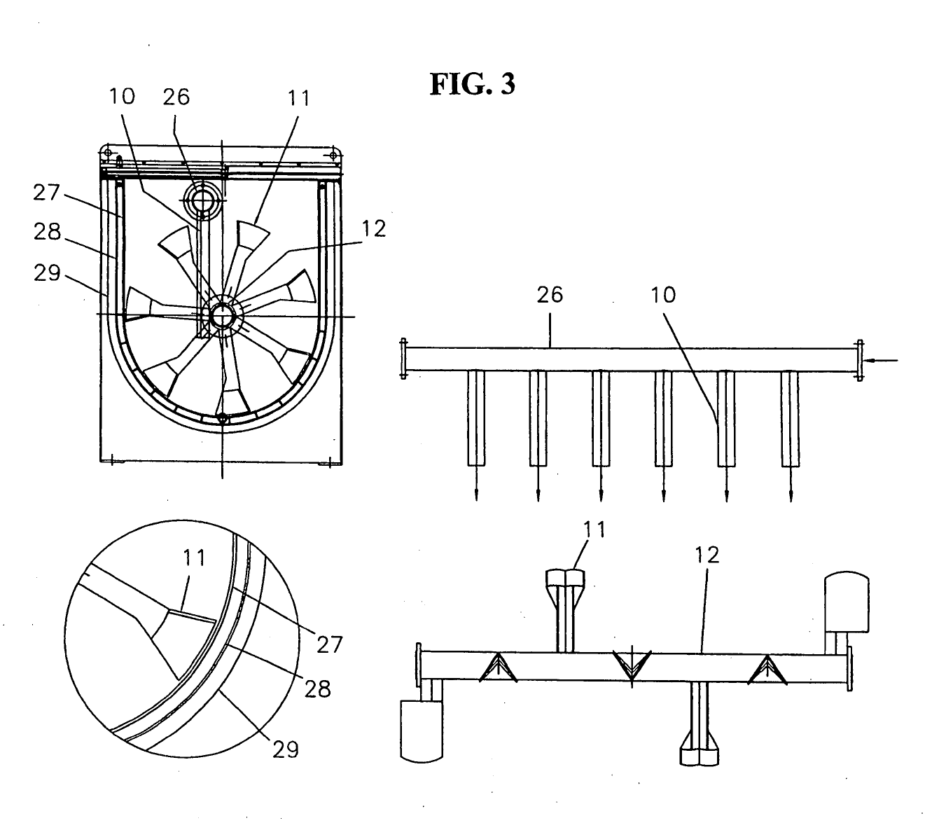

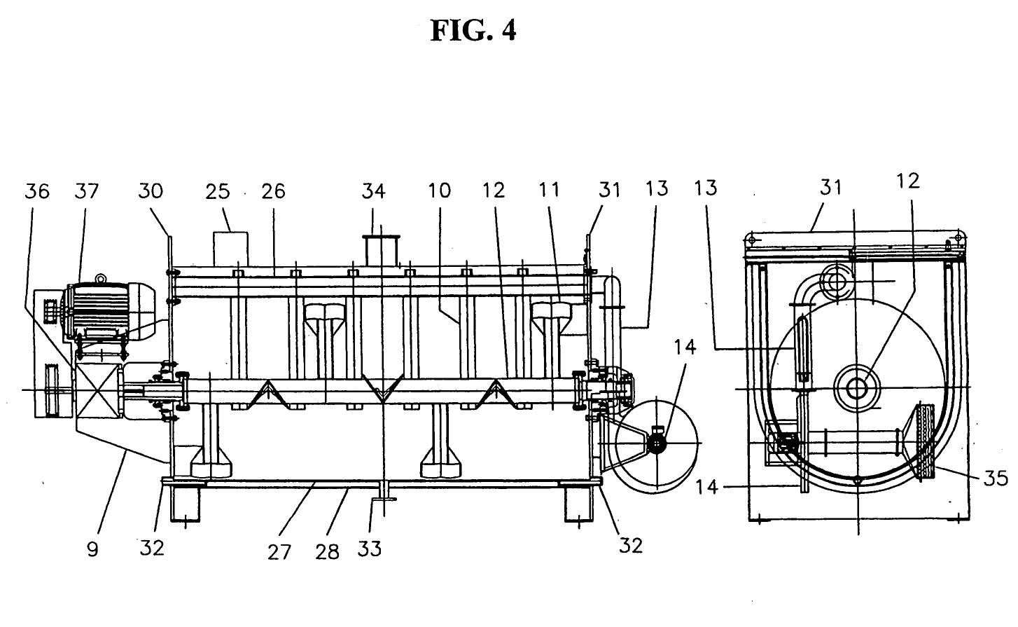

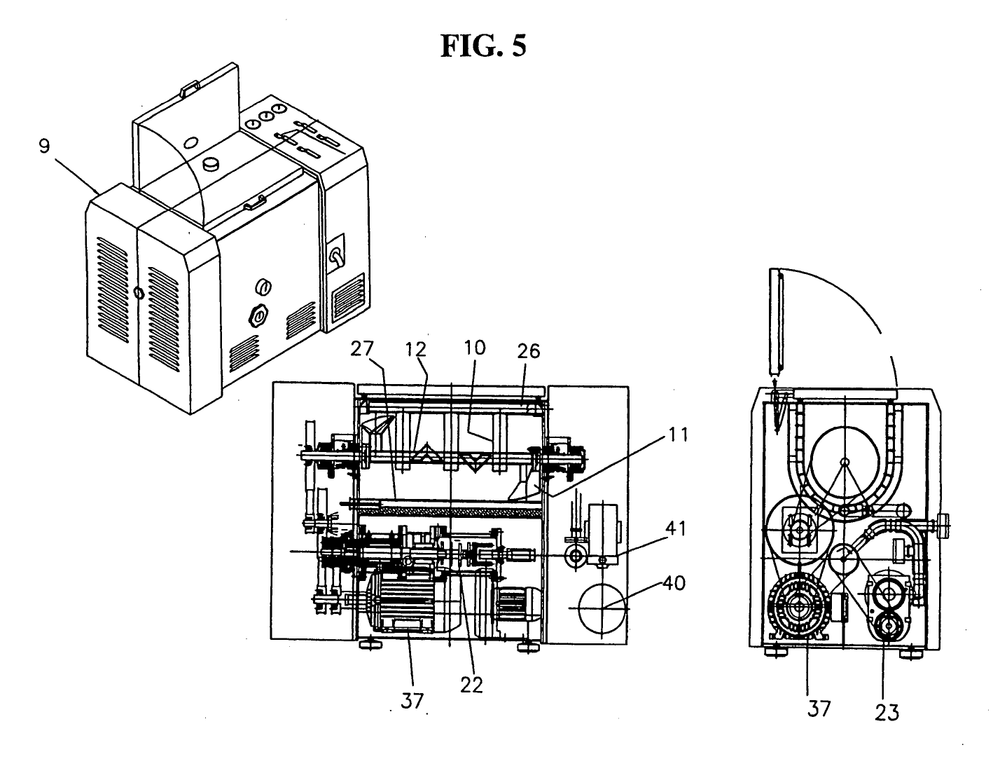

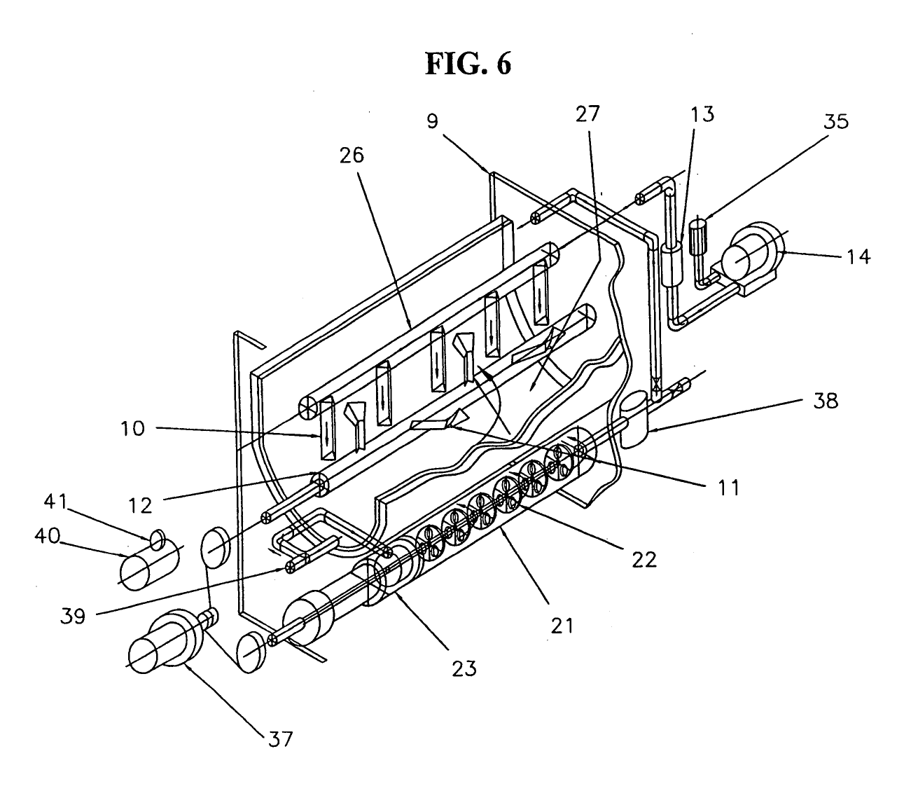

FIG. 2 shows a schematic outlook view of the conch in accordance with the present invention.

### EXAMPLE OF THE IMPLEMENTATION OF THE INVENTION

Operational characteristics procedure using chocolate mass processing technology in the “U” type conch 9 for intensive processing of chocolate mass.

First Stage: Pre-Grinding

This processing starts with the pre-grinding of the crystal sugar and the powder milk (when it is the case of chocolate milk), using a dynamic impact mill 4 of the type of rotor and stator and calibrating sieve, which will be operating with a rotation between 3,000 to 9,000 rpm and will use a sieve with drilling holes diameters varying from 0.5 to 3.0 mm. As a result, a sugar ground power of 10 to 200 micra thickness range will be achieved with physical characteristics of final ground sugar particles dimensions that are within the above mentioned range.

Second Stage: Conching

The product (the mixing of pre-ground sugar and powder milk) with the above mentioned characteristics (thickness between 20 and 200 micra) moves forward through an adequate transporting thread type transportation system to “U” type conch 9 for intensive chocolate processing. This system was especially developed to perform this processing stage, and that is also the purpose of this invention. In this stage, it is added part of the liquid ingredients of the formulation, namely, butter and mass cocoa, which have been previously melted and heated at 50° C. through the heat water cycling in the water-jacketed bed of “U” type conch 9 for intensive chocolate treatment.

The formulation ingredients still in its initial pre-grinding stage are homogenized through the alternate movement of the agitator arms of the “U” type conch 9 for intensive treatment, thus forming a dry mass with a powder consistency due to a special dinamic rotative movement. In this stage, it is started the chocolate mass processing cycle denominated “dry conching” and it is provided the chemical interaction of sugar and proteins of the raw materials which develop the chocolate flavor.

The “U” type conch 9 for chocolate intensive processing, with the processing capacity that varies from 150 kg to 10.0 t capacity per processing batch is activated by a driving power that varies from 3 hp up to 100 hp respectively, due to the processing capacity. In its conception, it has been developed a special fixed arm 10 and agitator arms 11 system with the purpose to increase the chocolate dry mass exposition cycle to the pre heated air coming from the performed forced ventilation through a high pressure fan 14, flow and air pressure of which that vary from 2.0 m³/h to 10.0 m³/h and 600 to 400 mm water column respectively, and it is activated by an electric motor with power that varies from 3.0 to 5.0 hp (depending on the conch capacity). It also has a heating electric resistance 13 with power that varies in the range of 2,000 to 5,000 kW (depending on the fan used in the conch).

In the “dry conching”, the chocolate pre-grinding mass is submitted to an intense mechanical work by the agitator arms 11 of the “U” type conch 9 for intensive chocolate processing, providing a temperature increase due to the friction among the raw materials particlesm thus increasing the chocolate mass temperature that will vary among 60 to 90° C. With this work it is obtained the elimination of part of the humidity of 0.1 to 0.8% contained in the mass.

In this process the steam evaporation through the dragging effect will cause the carrying of a series of undesirable components and flavors that were originally in the cocoa mass. Such components and flavors that remained in the cocoa seeds fermentation and processing interfere negatively in the chocolate mass final flavor.

The exposition effect of this chocolate mass to the air oxidation action is intensified with the hot air injection coming from the high pressure fan 14 with the purpose of oxidating the acids remaining from the cocoa fermentation process, the largest concentration being of acetic acid, which also oxidates the tannins and anthocyanins which are the cocoa natural coloring that give to the chocolate mass flavor a strong astringent dose.

The processing characteristics in the “U” type conch 9 for intensive chocolate processing during the dry conching stage are intensified using a maximum exposition cycle of the chocolate dry mass to the hot air, which needs a six hours exposition per operation batch, regardless of the conch capacity which uses 50% of the power used in the conventional conching process.

Third Stage: Liquefaction and Cooling

In this state, the chocolate mass receives the remaining of the cocoa butter from the formulation through pump 17. It is then homogenized by the alternate movement of the agitator arms of the “U” type conch 9 for intensive chocolate processing. It will assume the pasty liquid form and thereafter it is cooled by a cold water injection cycling in the “U” type conch 9 for intensive chocolate processing and by the cold air insufflation provided by the high pressure fan 14 until the chocolate mass temperature reaches 39° C.

Fourth Stage: Chocolate Mass Final Grinding

The product (chocolate mass) in its liquid form is transferred through the positive displacement pump 23 to a refining rolling mill 21 of chocolate mass with grinding pot capacity that varies from 10 to 500 liters and activating power that varies from 7.5 to 200 hp and flow rate from 100 to 2,500 liters respectively. The rolling refining mill is provided with a cooling system of water jacket, with the purpose to keep the chocolate mass temperature that cycles in its interior submitted to a friction power caused by the rolling eccentric movement and that turn at high rotation (700 rpm) at the temperature of 60° C. The chocolate mass already refined (20-40 micra) is transported from the refining mill 21 to the stock tank 24 through pump 23, where in its final use state will wait for the adequate solidification moment.

Next, it is shown a flow chart description using a chocolate mass processing technology in a compact plant complex and a “U” type conch 9 for intensive chocolate processing.

As an example, fifty kilos sugar bags will be added to the sugar mill hopper 1 that has a vibrating feed channel 2 that feeds the cup lift 3 and that will further supply the sugar mill of the “turbomill” type 4. The ground sugar is deposited by gravity in the interior of a motorized stock bin 5 provided with rasper arms 6, where it is fully unloaded.

The amount of ground sugar deposited in the bin is exactly the fraction corresponding to the chocolate formulation that is intended to be manufactured and is reserved while it waits for the right moment to be unloaded in the “U” type conch 9 for intensive chocolate processing. The integral powder or skimmed milk comes from the formulation which is normally received in multifoliate bags, each containing twenty five kilos and that is also added to the mill hopper 1. It moves forward through the mill feed cup lift 3 and through turbo mill type 4 and is deposited in the ground sugar stocking bin 5, where it will wait the right moment for the dosing through the transporting thread 7 and 8 to the “U” type conch 9 for intensive chocolate processing. The cocoa butter provided in blocks with 25 kilos weight is added into the butter melter 16, which has especially been developed for this purpose.

The cocoa butter deposited in the melter recipient 16 remains at the temperature of 50° C. and is transferred through centrifuge pump 17 for the “U” type conch 9 for intensive chocolate processing. The cocoa mass, which is normally supplied in pieces conditioned in multifoliate bags of 25 kg, is added to the cocoa mass automated melter 18, which has been developed for this purpose.

The cocoa mass already in its pasty phase, kept at the temperature of 45° C., is transferred through a positive displacement pump 20 to the “U” type conch 9 for intensive chocolate processing. The next stage that is determinant in the chocolate mass manufacturing process is performed in the “U” type conch 9 for intensive chocolate processing.

The liquid ingredients, cocoa butter and cocoa mass that were reserved in the interior of the conch are heated at a temperature of 70° C. The dry ingredients, ground sugar and powder milk reserved in the stock automated bin 5 are transferred through transporting threads 7 and 8 to the processing chamber of the “U” type conch 9 for intensive chocolate processing, thus comprising partially the chocolate mass formula and providing for the mass formation with the consistency of a dry powder. In this stage (dry conching) the chocolate mass has a fat content of 16 to 20% of the chocolate mass final formulation.

The conch temperature control system will be adjusted to operate at the range of 60 to 80° C. until the end of the process. During this stage that may take four to six hours, fan 14 and resistance 13 will be activated to inject heat air (70° C.) into the interior of the chocolate mass, thus reaching an excellent performance in the extraction of humidity and of the undesirable volatile matter in the chocolate mass.

In the next stage, denominated liquefaction and refine, the remaining of the formulation butter stocked in the butter melter 16 will be transferred to the interior of the “U” type conch 9 for intensive chocolate processing through pump 17 liquefying and homogenizing the chocolate mass, while it cools the mix at 45° C. by using the water jacket system of the conch processing chamber, where at this phase the cold water process cycles.

The liquefied chocolate mass is transferred to the rolling refiner mill 22 through pump 23 to be ground. During this phase, the chocolate temperature is kept at 60° C. through a cooling system provided by the cold water cycle in the mill water jacket.

The chocolate mass returns to the chamber of the “U” type conch 9 for intensive chocolate processing. The chocolate mass circulates through this equipment until it reaches the desired thickness, and deviates thereafter to the stock tank 24 the finished chocolate mass.

1. Process for manufacturing chocolate mass, characterized by comprising the following steps:
a) dry pre-grinding of the raw material received in its original dry form until a desired thickness following through a mechanized transportation to the next stage;
b) conching of the pre-grinding product with the desired thickness characteristics in a “U” type conch (9) for intensive chocolate processing, in which part of the liquid ingredients of the formulation is added, after being previously melted and heated at an adequate temperature in such a way that the formulation ingredients still in their pre-grinding initial stage are homogenized by the alternative movement of the agitator arms of the “U” type conch (9) for intensive chocolate processing, through a special dynamic rotating movement, thus forming a dry mass with a consistency of a powder;
c) liquefying and cooling the chocolate mass, where it receives the remaining of the cocoa butter of its formulation, being homogenized by the alternative movement of the agitator arms of the “U” type conch (9) for intensive chocolate processing, thus assuming a pasty liquid state, and thereafter, cooled through the injection of a refrigerating fluid that circulates in the water jacket of the “U” type conch (9) for intensive chocolate processing and by the insufflation of cold air provided until the chocolate mass reaches the desired temperature;
d) chocolate mass final grinding, in which the chocolate mass in its liquid state is transferred to a chocolate mass refining mill (21) provided by a refrigeration system, with the purpose to keep the temperature of the chocolate mass, which circulates in its interior submitted to a friction power in the adequate value and in which the chocolate mass already refined is transported from the refining mill to a stock tank (24) and, in its final state of use, waits for the adequate solidification moment.

2. Process in accordance with claim 1, characterized in that the raw material consists of cocoa mass and butter, sugar and powder milk.

3. Process in accordance with claim 1, characterized in that the ground material of step a) is 10 to 200 micra thick.

4. Process in accordance with claim 1, characterized in that the temperature in which the melted ingredients have been heated in the step b) is about 50° C.

5. Process in accordance with claim 1, characterized in that the temperature of the chocolate mass is increased to 60-90° C. in the step b).

6. Process in accordance with claim 1, characterized in that the cooling fluid in step c) is water.

7. Process in accordance with claim 1, characterized in that the desired temperature of the chocolate mass in step c) is about 39° C.

8. Process in accordance with claim 1, characterized in that the chocolate mass temperature in step d) is about 60° C.

9. Process in accordance with claim 1, characterized in that the chocolate mass thickness in step d) is about 20-40 micra.

10. Machine for the chocolate mass processing, characterized by comprising a structure made of a U type conch (9), an agitator axis (12) in which a fixed arm (10) and agitator arms (11) are articulated for increasing the chocolate dry mass exposition cycle to the pre-heated air coming from a forced ventilation performed through a high pressure fan (14), activated by an electric motor with a heating electric resistance (13).

11. Machine in accordance with claim 10, characterized in that the U type conch (9) has jacketed walls to receive a refrigeration fluid.

12. Compact installation for the chocolate mass processing, characterized by comprising a disposition of germinated equipments where a sugar mill (4) is located above the U type conch (9) thus making feasible the direct dry grinding of the ingredients in the U type processing conch followed by the junction of the cocoa refining mill (21) in the side of the U type conch structure thus forming a monolitic block of equipments occupying an extremely reduced physical area.
